(19) United States
(12) Patent Application Publication
(10) Pub. No.: US 2021/0398232 A1
(43) Pub. Date: Dec. 23, 2021

(54) SYSTEM AND METHOD FOR IMPLEMENTING A MARKET DATA CONTRACT ANALYTICS TOOL

(71) Applicant: JPMorgan Chase Bank, N.A., New York, NY (US)

(72) Inventors: Ilya Slavin, Brooklyn, NY (US); Michelle ROBERTS, Hertfordshire (GB); Ian BONE, Renfrewshire (GB); Wilson De Sousa FERREIRA, New York, NY (US)

(21) Appl. No.: 16/904,156

(22) Filed: Jun. 17, 2020

(51) Int. Cl. G06Q 50/18; G06F 21/44

(52) U.S. Cl. CPC G06Q 50/18; G06Q 2220/18; G06F 21/44

(57) ABSTRACT

An embodiment of the present invention is directed to providing market data contract analytics. The innovative system and method are directed to market data contract analytic tools that provide the ability to visualize rights an entity has licensed from various providers or sources. The market data contract analytics tools may further provide searching capabilities (e.g., full text searching, etc.), visualization of agreements the entity has signed or entered into (e.g., linkage, terms, etc.), and performing analytics on various aspects of the agreements including associated text and metadata. An embodiment of the present invention permits entities that license information to merge workflows that exist in contract negotiation, new product research, rights enforcement, tracking impact of contract changes, responses to third party audits and/or other factors and considerations.

### FIELD OF THE INVENTION

The invention relates generally to a system and method for implementing a market data contract analytics tool.

### BACKGROUND OF THE INVENTION

Global entities, such as financial institutions, may spend over hundreds of millions of dollars on market data, which can be used by hundreds of applications and thousands of individual users. This results in agreements with hundreds of data vendors and Exchanges, some of which could be very complicated. For a large financial entity, it is common to have thousands of unique and individual agreements in force. Nearly all agreements are on vendor originated paper, diluting definition of terms. New or replacement agreements are signed every year with annual cost increases up to 25% in some cases. Currently, agreements are managed manually in paper format. Most lines of businesses (LOBs) do not fully understand usage rights and entitlements. This results in increased risk and non-compliance issues. In addition, it is common to have concurrent exchange audits at any given time.

For a financial institution, there is a tremendous amount of contracts for market data where each contract can be unique in nature. Additional new rights may be negotiated and acquired through contracts. There certain types of data that have multiple unique agreements in force to cover different usage rights for different groups of consumers. The ability to manage many contracts is not unique to market data and is an issue relevant to many lines of business. For example, consumer banking entities may manage a large amount of agreements for credit reporting and other purposes. Current solutions fail to provide a comprehensive approach to managing contracts, spend, or rights, but typically not more than one of these categories. This results in lack of coordination between business support groups or lines of business, and there is a risk of overspend due to lack of coordination.

These and other drawbacks exist.

### SUMMARY OF THE INVENTION

According to one embodiment, the invention relates to a system that provides market data contract analytics. The system comprises: a portal that interfaces with user within a line of business via a network communication; a memory component that stores data relating to a plurality of contracts associated with the line of business; and an analytics engine that comprises a computer processor and is coupled to the memory component and the portal; the computer processor is further configured to perform the steps of: initiating, via the portal, a contracting process; receiving, via an electronic communication, one or more orders of rights for the line of business, wherein the one or more orders of rights relate to digital rights management (DRM); identifying, via the analytics engine, an aggregate set of orders across multiple lines of business for a contract negotiation process; accessing, via a contract application, a final contract; and providing, via the portal, a visualization of the final contract within a tree structure that identifies parent and child contract relationships, applies corporate mapping for the multiple lines of business and provides search functionality based on key contract terms.

According to one embodiment, the invention relates to a method that provides market data contract analytics. A method comprises the steps of: initiating, via a portal, a contracting process, wherein the portal interfaces with a user within a line of business via a network communication; receiving, via an electronic communication, one or more orders of rights for the line of business, wherein the one or more orders of rights relate to digital rights management (DRM); identifying, via an analytics engine, an aggregate set of orders across multiple lines of business for a contract negotiation process; accessing, via a contract application, a final contract; and providing, via the portal, a visualization of the final contract within a tree structure that identifies parent and child contract relationships, applies corporate mapping for the multiple lines of business and provides search functionality based on key contract terms.

The system may include a specially programmed computer system comprising one or more computer processors, interactive interfaces, electronic storage devices, and networks. The computer implemented system, method and medium described herein provide unique advantages to entities, organizations, market data consumers and other users, according to various embodiments of the invention. An embodiment of the present invention is directed to providing a comprehensive view on different parts of a lifecycle of how contracts become rights and how the rights are being used. Current solutions fail to provide useful insights on rights obtained through a contract, without requiring a full manual analysis or read of the contract itself. Current solutions focus on the mechanics of signing contracts but fail to provide insights as to what contract terms mean to a user, set of users or an entity, e.g., why was the contract entered, how do users use it, etc. An embodiment of the present invention is directed to correlating insight information to determine whether certain actions can be performed across a single source or multiple sources. In addition, an embodiment of the present invention seeks to determine what happens when a source changes or updates terms in the contract and further identifies who will be impacted by the change or update. Other determinations may include identifying users who will be impacted by a particular decision, who is using data in a particular way, etc. With an embodiment of the present invention, users are empowered to realize savings in effort on management and direct spend on data. The innovative system and method seek to reduce hidden legal and other risks of non-compliance with data licensing contracts or agreements by ensuring that data usage patterns match existing data licenses. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system diagram, according to an embodiment of the present invention.

FIG. 2 is an exemplary user interface, according to an embodiment of the present invention.

FIG. 3 is an exemplary user interface, according to an embodiment of the present invention.

FIG. 4 is an exemplary flow diagram, according to an embodiment of the present invention.

FIG. 5 is an exemplary parentage tree interface, according to an embodiment of the present invention.

FIG. 6 is an exemplary flowchart, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to an analytics engine that provides market data contract analytic tools that enable users to visualize usage rights. Users may include market data analysts, personnel overseeing compliance with market data agreements, sourcing and legal personnel. For example, the market data contract analytic tools may provide the ability to visualize rights an entity has licensed from various providers or sources. The market data contract analytics tools may further provide searching capabilities (e.g., full text searching, etc.), visualization of agreements the entity has signed or entered into (e.g., linkage, terms, etc.), and analytics on various aspects of the agreements including associated text and metadata. An embodiment of the present invention permits entities that license information to merge workflows that exist in contract negotiation, new product research, rights enforcement, tracking impact of contract changes, responses to third party audits and/or other factors and considerations.

An embodiment of the present invention is directed to a unified data model and workflow that connects various facets of market data consumption in an entity of any size. According to an exemplary illustration, an embodiment of the present invention may use a distributed search engine (e.g., Elastic Search) and content extraction technology (e.g., Optical Character Recognition (OCR)) to liberate the data model and enable disparate data sources to be combined to generate advanced analytics, integration with Digital Rights Management (DRM), intelligent search capabilities, etc.

With an embodiment of the present invention, users are empowered to realize savings in effort on management and direct spend on data. The innovative system and method seek to reduce hidden legal and other risks of non-compliance with data licensing agreements by mathematically proving that data usage patterns match existing data licenses.

The nuances of market data make such contracts unique in terms of the way they are constructed and how resources can be leveraged to create something that can then be sold on downstream. With market data, the resultant product's ownership is not well understood and in some cases, another entity could then claim ownership of the derived data—a significant risk in industry. For Exchange agreements, a financial entity may not even have control over changes. In this example, a vendor may simply publish notifications to alert of changes, which can occur at any time and without warning.

An embodiment of the present invention may be applied to contracts involving market data as well as other types of contracts in various lines of business that rely on a large number of contracts and rights management, e.g., what do the agreements allow them to do; is an entity buying how it can use its purchase, etc. This may generally involve identifying rights from an agreement, contract, subscription, etc. An embodiment of the present invention may identify whether the person negotiating the contract asked (or did not ask) critical questions and further ensure that the person negotiating the contract is equipped to negotiate for key terms and rights. The various embodiments of the present invention are not limited to market data and may be applied to various lines of business, applications, use cases and industries.

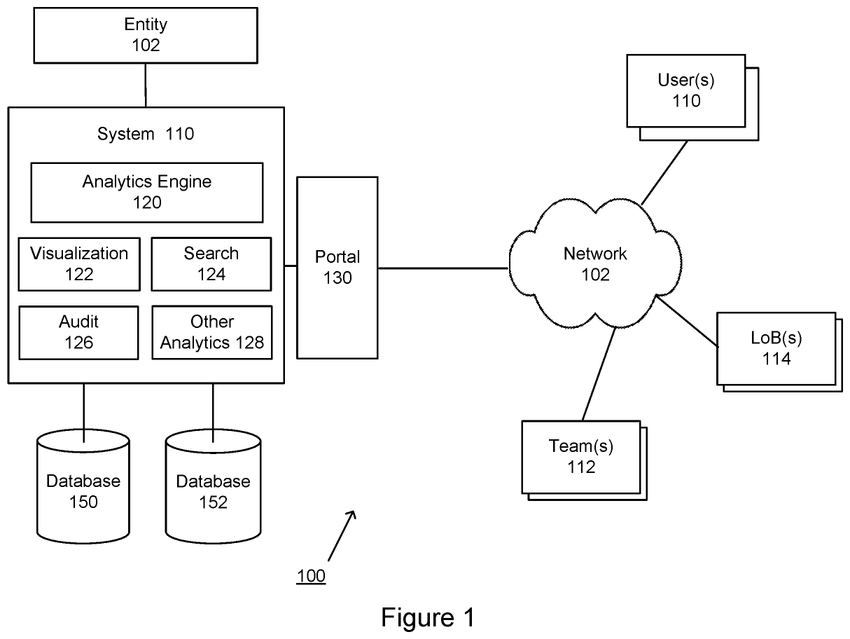

FIG. 1 is an exemplary system diagram, according to an embodiment of the present invention. FIG. 1 may include System 110, Analytics Engine 120 and Interactive Portal 130. System 110 may organize information and notes during contract negotiations. Analytics Engine 120 may be driven by an entity's executed agreements. Analytics Engine may be integrated with various applications, services, platforms and/or systems. For example, Analytics Engine 120 may enable users to acquire and request rights and also manage existing rights. Analytics Engine 120 may provide comprehensive information to enable users to better negotiate terms for new contracts and also make informed decisions at renewal. Analytics Engine 120 may include functions and features including Visualization 122, Search 124, Audit 126 and other analytics represented by 128. Visualization 122 may generate interactive and dynamic visualizations of contracts/agreements, terms, rights, permissions, DRM description, etc. Visualization 122 may also provide data in various formats including a tree format with linkage (e.g., parent and child agreements/contracts), organization hierarchy, etc. Other related information may include an expiration calendar, notifications, alerts, etc. Search 124 may provide the ability to search by rights, including DRM rights, ODRL search features, etc. Audit 126 may provide an audit trail function and other logging features. Portal 130 may represent an interactive user interface or an application compliance portal that allows application owners to define how their application needs to use licensed contracts with automated compliance checks and also provides an ability to determine an impact of actions by any specific licensor(s).

Entity 102, such as a financial institution, may host System 110. Users may interact with Portal 130 via Network 102. Portal 130 may provide an interactive user interface that receives user's inputs and requests. Users may include individual users 110, Teams 112, Lines of Businesses 114 and/or other users. User 110 may communicate with Portal 130 via Network 102 to access System 110 and Analytics Engine 120. Analytics Engine 120 may send and/or receive data from various sources, including Database 150, 152. Databases 150, 152 may store data relating to agreements, contracts, terms, analytics, visualizations, tree data, rights, etc.

The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 are depicted, it should be appreciated that other connections and relationships are possible. The system 100 described below may be used to implement the various methods herein, by way of example. Various elements of the system 100 may be referenced in explaining the exemplary methods described herein.

Network 102 may be a wireless network, a wired network or any combination of wireless network and wired network. For example, Network 102 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Network 102 may support an Internet network, a wireless communication network, a cellular network, Bluetooth, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although Network 102 is depicted as one network for simplicity, it should be appreciated that according to one or more embodiments, Network 102 may comprise a plurality of interconnected networks, such as, for example, a service provider network, the Internet, a cellular network, corporate networks, or even home networks, or any of the types of networks mentioned above.

Data may be transmitted and received via Network 102 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 1 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals. Portal 130 may represent a user interface and/or other interactive communication portal.

System 110 may be communicatively coupled to Databases 150, 152. Databases 150, 152 may include any suitable data structure to maintain the information and allow access and retrieval of the information. For example, Databases 150, 152 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Databases 150, 152 may be any suitable storage device or devices. The storage may be local, remote, or a combination thereof with respect to Databases 150, 152. Databases 150, 152 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Databases 150, 152 may have back-up capability built-in. Communications with Databases 150, 152 may be over a network, or communications may involve a direct connection between Databases 150, 152 and Entity 102, as depicted in FIG. 1. Databases 150, 152 may also represent cloud or other network based storage.

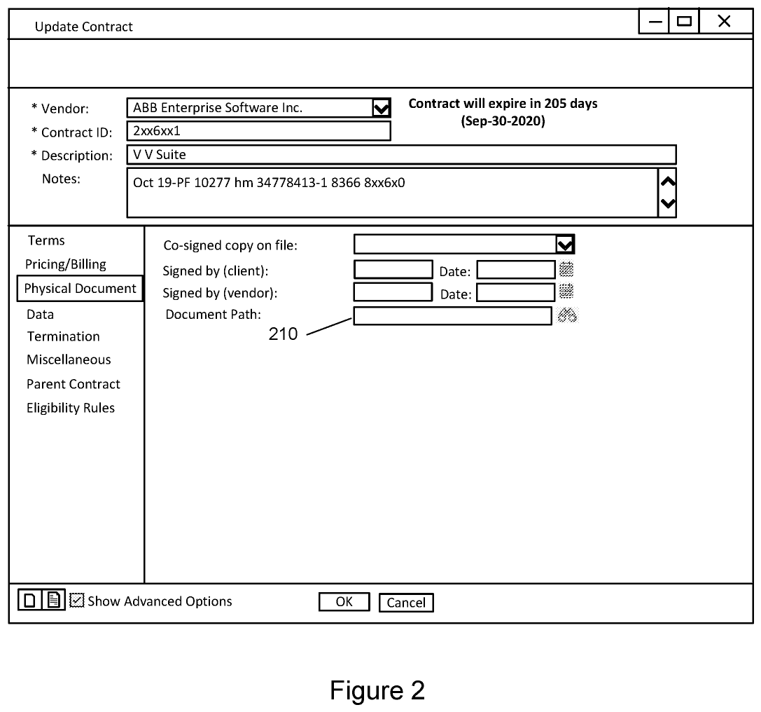

FIG. 2 is an exemplary user interface, according to an embodiment of the present invention. As shown by FIG. 2, a user may enter data relating to Vendor identifier (or name), Contract identifier, Description and Notes. Contract expiration data may be displayed. User may also provide information relating to co-signed copy on file; signed by (client), signed by (vendor) and document path. Other information may relate to Terms, Pricing/Billing, Physical Document, Data, Termination, Miscellaneous, Parent Contract and Eligibility Rules. A hyperlink may be added to a document path field at 210.

As shown in FIG. 2, an embodiment of the present invention provides integration with a third party solution. FIG. 2 is an exemplary application that divides a massive contract into multiple portions and assigns each portion to a relevant team or users who may then use the corresponding portion. As shown in FIG. 2, an embodiment of the present invention may provide a URL at 210 that is linked from the third party system which then automatically triggers a search for documents and other resources.

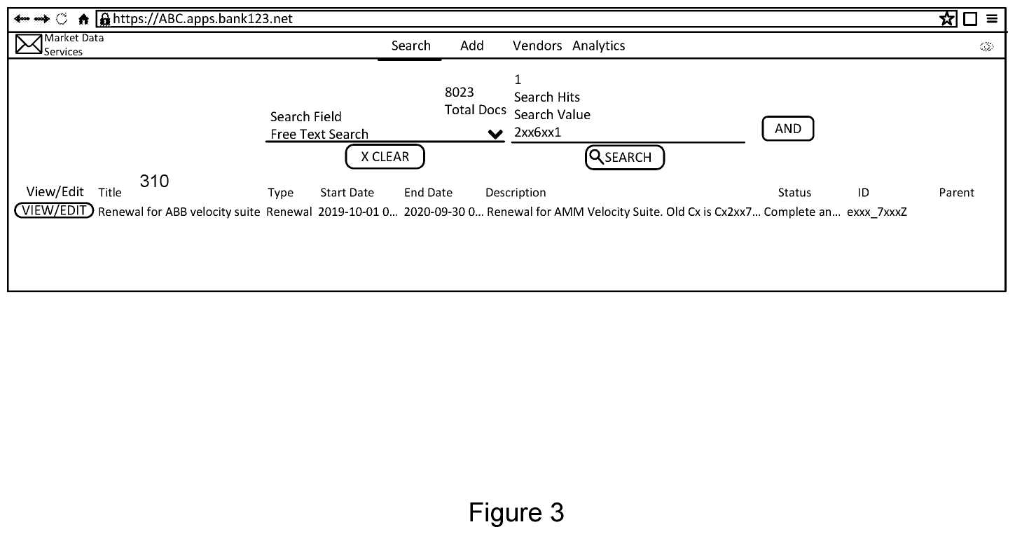

FIG. 3 is an exemplary user interface, according to an embodiment of the present invention. The document path field identified by 210 in FIG. 2 may execute a search for an associated number (or identifier) of the contract in question. Searches may include free text search, search within a specific field, an identifier search, etc. Various search options may be applied (e.g., Boolean, natural language, voice, etc.). For example, a search may be executed for an identifier. As shown by FIG. 3, a total number of documents may be displayed along with the number of search hits. The search results may be provided at 310 with details including Title, Type, Search Date, End Date, Description, Status, Identifier, Parent, etc. A user may perform various actions, including View/Edit. Other actions may be available. The results table 310 may be further filtered by adding criteria from search terms, or specific DRM permissions, such as applicability to a specific Line of Business.

An embodiment of the present invention is directed to moving from a repository of documents to a structured interactive system that provides a comprehensive view based on a final version of the contract. For example, an embodiment of the present invention is directed to structuring information in a database from the perspective of completed contracts rather than a set of disbursed information.

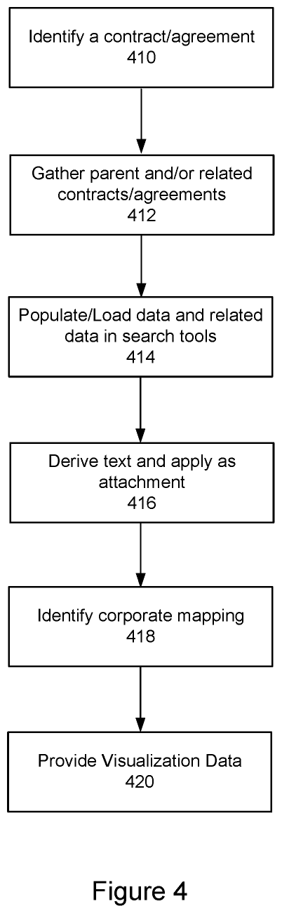

FIG. 4 is an exemplary flow diagram, according to an embodiment of the present invention. At step 410, a contract/agreement may be identified by a unique identifier. For example, a contract ticket lifecycle may begin with an identifier being entered by a user or automatically provided. Identifiers may be extracted from various applications and other sources. For example, identifiers may be run through a reporting database. At step 412, parent and/or related contracts, agreements, etc. may be gathered. For example, this step may be repeated for parent identifiers and continue until all or a comprehensive set of parents and/or associated identifiers are gathered. At step 414, contract/agreement data may be populated in Search Tools. For example, data may be loaded in a search engine (e.g., Elastic, etc.). In this example, key fields may be imported as data and the full record may be attached as a database entry, e.g., Binary Large Object (Blob), collection of binary data, etc. Active identifiers may be updated on a periodic basis (e.g., nightly, non-active weekly, etc.). For example, using an identifier as primary key, a record retrieved from an external repository of a fully negotiated and signed agreement may be connected to records already present in the search engine that relate to draft version of the same agreements, or other related information. At step 416, OCR may be applied to derive text from an image by a local function or an external service (e.g., in-house service, Cloud based, etc.). The text may then be attached to a binary file's record in the search engine. For example, scanned copies of agreements or binary files representing drafts may be retrieved from external system and stored attachments to the record. Such attachments may be identified in earlier records sharing the agreement identifier as primary key, in which case those earlier attachments will be re-attached to the new record for the final agreement. At step 418, corporate entity mapping may be extracted and maintained to determine relationship, e.g., company relationships as well as links and other associations. This mapping can be used to maintain suppliers' linkage to ultimate parent entities as suppliers change names and go through mergers and acquisitions during lifetimes of some agreements. At step 420, Digital Rights Management (DRM) data may be provided either through special user interface screens, or it may be attached to the record if a relevant data is provided with the contract by an external source. While the process of FIG. 4 illustrates certain steps performed in a particular order, it should be understood that the embodiments of the present invention may be practiced by adding one or more steps to the processes, omitting steps within the processes and/or altering the order in which one or more steps are performed.

An embodiment of the present invention may be directed to providing visualization features through reports, interfaces and other outputs. Features may include contracts by vendor in a tree form, terms in a contracts tree, expiration calendar, contracts that apply to organization hierarchy, search by DRM rights, etc. Other formats and variations may be realized.

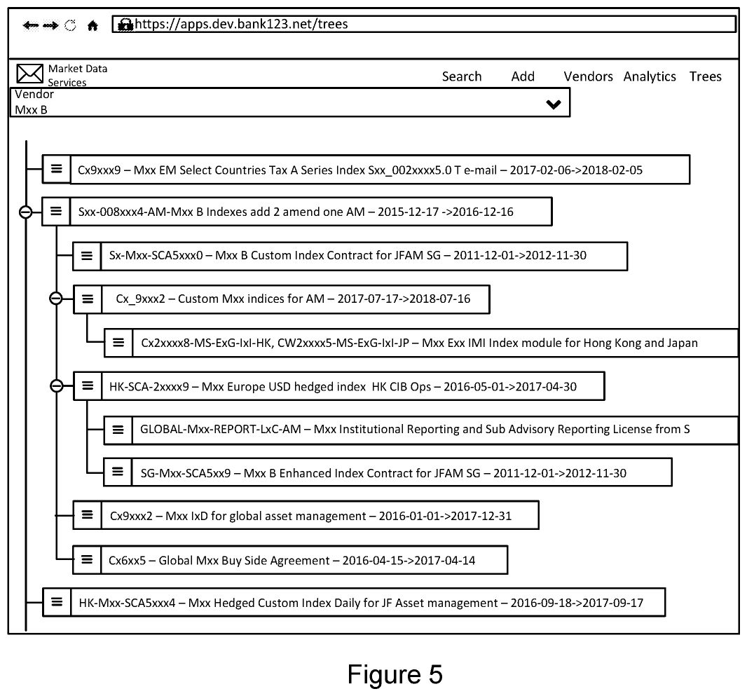

FIG. 5 is an exemplary parentage tree interface, according to an embodiment of the present invention. An embodiment of the present invention may be directed to tree views or other visualizations. For example, a user may select a vendor and then view associated contracts in a hierarchical format. This may include contracts associated with the vendor as well as corporate children. Other affiliates, subsidiaries and/or associated entities may be displayed. For example, if the contracts have children, the contract may be drawn in a tree form. This information may be predetermined as well as dynamically generated in real-time.

FIG. 5 is an exemplary view that displays contacts by vendor. For example, each entry may represent a contract identified by an identifier and further include information about the contract. These entries are structure in a tree form, where subordinate agreements are represented as leaf nodes from the contract they are subordinate to, such as addenda to the Master Services Agreements. Multiple levels are possible, for example, Exhibits would be shown as leaf nodes under Schedules, which in turn would be leaf nods until Addenda, etc. As shown in FIG. 5, contracts may be re-linked up to proper parent via drag and drop and then saved to a search tool, e.g., Elastic Search. Related contracts may be displayed via a tree structure as illustrated by a series of nodes. Other graphics and illustrations may be provided.

As shown in FIG. 5, the tree view may restructure how agreements may be viewed and searched rather than identifying an agreement in isolation. An embodiment of the present invention is directed to providing a comprehensive and contextual understanding of agreements (and even portions of agreements) for comparison and analysis. For example, an embodiment of the present invention is directed to providing parentage details associated with agreements. This may refer to identifying lineage, associations, similarities, and/or other affiliations. With parentage of agreements information, an embodiment of the present invention may provide linkages between agreements to indicate which agreements are children of other agreements. In addition, an embodiment of the present invention may facilitate searches that enable users to visualize a flow and also modify the flow.

Users may also interact with the tree form. Modifications to the flow may be performed by a drag and drop action. Other inputs and actions may be supported. For example, users may be authorized to drag and drop contracts to “fix” trees and provide quick links to view a version/format (e.g., PDF) of the contract and/or “edit” the database entry that describes the specific agreement. The overrides established by the authorized users to restructure the tree may be marked as such in the database to prevent them being overwritten at a next system refresh. In addition, users may toggle between multiple views, including Active-only and All-contracts views.

An embodiment of the present invention may be directed to providing terms in a contracts tree. For example, a user may select a contract and one or more terms. An embodiment of the present invention may then search (e.g., in OCR) for the term and then display the relevant paragraph(s) or context. An embodiment of the present invention may apply the same or similar process for the parent contracts in a chain as well as the children contracts in a chain. An embodiment of the present invention may then display the results as a tree (or other format) matching contractual parent/child relationship. Other formats and visualizations may be applied.

The visualization of terms a contracts graphical structure (e.g., contracts tree) may be of particular interest to a legal team or lawyers. For example, an entity may have contracts with vendors who redefine terms. As a user interacts with a contracts tree, an embodiment of the present invention may illustrate that a master agreement may define derived data one way, a schedule may define the same data in a different manner, an addendum may define the data in yet a different way, and finally an exhibit may apply something different. In this example, each definition may be in force at any moment in time depending on a specific use case. With this feature, a user may search on the value of a particular term through a tree of agreements to determine how the vendor actually wants to define it. This may be performed from the perspective of normalizing the languages of a negotiation but also from the perspective of being able to answer a question directed to whether a particular user in a particular line of business can perform a specific function and/or action.

An embodiment of the present invention is directed to providing an expiration calendar. This feature identifies contracts (or portions of contracts) that are expiring within a time period (e.g., days, months, etc.) or other event or condition. The expiration calendar may be represented as 30-60-90 day calendar of contracts that are expiring. Other intervals may be applied. This may indicate that a team should start talking to vendors. An embodiment of the present invention may provide an ability to integrate notifications, alerts and calendar reminders. For example, a calendar reminder may be automatically added to initiate discussions or negotiations. This feature avoids situations where entities inadvertently let agreements expire and continue working off expired agreements for years which would lead to risks and inefficiencies.

An embodiment of the present invention may be directed to identifying contracts that apply to an organization hierarchy. For example, DRM sections may be populated for contracts. Some contracts may apply across various lines of business within an organization hierarchy. A particular team, such as asset wealth management, may not care or have any need to access information or be bound by terms that does not apply to them. An embodiment of the present invention may accordingly limit a search for information based on the requesting or relevant team or type of data rights. For example, a user may limit a search or other analysis to a particular hierarchy, or only results that allows an entity or line of business to redistribute information. An embodiment of the present invention may be directed to filtering searches based on rights language, terms and/or other filter.

In addition, a user may search by DRM right. This may occur when a corresponding ODRL is generated. ODRL represents Open Digital Rights Language. An embodiment of the present invention may be integrated with an ORDL visualizer that automatically translates digital agreements from machine readable language into human readable language. The ODRL Visualizer is described in co-pending and commonly assigned patent application titled “System and Method for Implementing an Open Digital Rights Language Visualizer” (U.S. Ser. No. 62/957,443, filed Jan. 6, 2020 (Attorney Docket Number: 72167.001810), the contents of which are incorporated by reference herein in their entirety.

An embodiment of the present invention may be directed to generating and integrating digital rights language. For example, the system may generate a set of computer readable rights that describes certain characteristics of the contract. This may include what the contract actually users do, what the contract applies for, what are a user's restrictions, what are the obligations, etc. An embodiment of the present invention may be directed to generating a graphical interface for various users, including non-technical users. Users may interact (e.g., click buttons, etc.) and in response, the system may generate the corresponding ORDL language to be associated with an agreement.

An embodiment of the present invention may be directed to managing acquired rights and the applications that are using the rights. For example, multiple application teams may be using various rights in their applications. In this example, a trading interface, an electronics hedging system and an index generator may each consume licensed data and transform and send out data in a particular way. An embodiment of the present invention may allow application owners to define how their application consumes rights via a dedicated presentation of the portal. Such rights would captured in the ODRL format, which can then be used to re-certify usage on regular basis or be used to calculate a sum total of all data right that applications consume on behalf of a particular business. This data can be utilized to make certain proper data licenses were acquired in order to be able to succeed on behalf of their business, and to help business entities confirm they are not licensing content they do not actually consume.

According to an embodiment of the present invention, the system may provide various users an ability to request rights. For example, a user may interact with an interface and specify rights that are needed to complete a task, project, service, etc. The rights may be identified for purchase or negotiation with a vendor or source. This may be represented as an order form interface with dropdowns, checkboxes and other icons. The order form interface may be used to generate the ODRL which may then be associate with a request record. When an entity acquires the rights by signing or executing the contract, an embodiment of the present invention may then systematically compare with the requested rights to determine or confirm whether the requested features and functions were properly captured by the agreement.

For example, an embodiment of the present invention may enable users to identify who they are, what their business is, what assets they need, and then define the rights that they need in order to reach the business value that they are trying to reach. Am embodiment of the present invention utilizes one or more corporate directory or data source to automatically place the user into these categories by examining their role in the organization. An embodiment of the present invention may then generate corresponding ODRL. With this, an embodiment of the present invention may provide various features and benefits, including (1) mathematically proving that an entity has a set of rights; and (2) if the rights are not established, the request may be escalated and addressed.

An embodiment of the present invention may collect data from various agreements and applications. With enough data in the system, an embodiment of the present invention may receive a request regarding rights or actions to be performed on behalf of the business. An embodiment of the present invention may identify whether the request is consistent and covered by rights associated with the agreement. For example, a system may determine that the requesting user is trying to do something that was not requested in the agreement. A user may be attempting to perform an action that is something that the business does not want to do. According to another scenario, an embodiment of the present invention may identify that the business needs to address the problem and seek to include the requested action as part of the agreement. Additional details are provided in co-pending and commonly assigned patent application titled “System and Method for Implementing Market Data Rights Enforcement,” (U.S. Ser. No. 16/563,106, filed Sep. 6, 2019 (Attorney Docket Number: 72167.001770), the contents of which are incorporated by reference herein in their entirety.

An embodiment of the present invention may be directed to gathering and analyzing information from various application teams to identify what the application team is attempting to do and specifying associated assets. An embodiment of the present invention may be directed to provide a notification or alert when data rights are being changed without prior notification on a particular set of assets. This may include when Exchanges change data rights without prior notice. An embodiment of the present invention may be directed to simulating an impact tree. This feature may indicate that a vendor wants to modify a definition of derived data, for example. An embodiment of the present invention may identify users of the derived data. Users may include actual users, teams, applications, etc. An embodiment of the present invention may then notify via an electronic communication of the change. The notification may identify terms that are changing from A to B and an explanation of what that means to a particular user, application, service, team, etc. The users may respond and indicate any issues or inconsistencies that may be associated with the change.

According to an exemplary scenario involving an audit situation, an exchange may want to know applications that use information in a certain way. This exemplary scenario may involve building an index and deriving information to distribute to customers. An embodiment of the present invention may be directed to a Compliance Portal where reports may be generated. This may involve a report starting with an originator of information, assets associated with the originator, and others that use those assets based on self-reporting, for example.

An embodiment of the present invention may be directed to creating an audit trail and/or a non-repudiation feature. For example, another team may indicate that a particular feature or function was not properly captured. An embodiment of the present invention may determine whether the feature or function was part of the original order. An embodiment of the present invention may be directed to automating the request workflow.

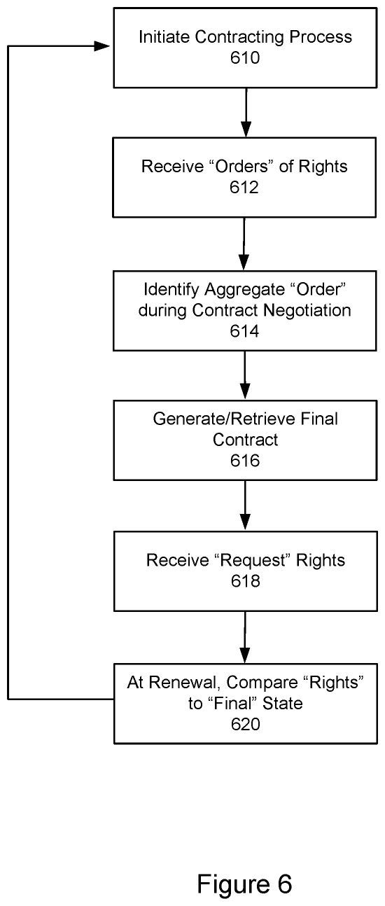

FIG. 6 is an exemplary system architecture, according to an embodiment of the present invention. An embodiment of the present invention may be directed to an application compliance portal and generating self-reported rights expression in ODRL. With an embodiment of the present invention, users may achieve control related to fulfillment, enforcement and reporting. An application compliance portal may generate a rights usage request in ODRL and may be further driven by business terms rather than implementation details.

FIG. 6 is an exemplary flowchart, according to an embodiment of the present invention. As shown in FIG. 6, digital rights management may take control of a contracting pipeline in a mathematically verifiable manner. At step 610, a contracting process may be initiated. At step 612, “orders” of rights may be received. At step 614, an aggregate “order” may be identified during contract negotiation. At step 616, a final contract may be generated or retrieved from another application or system, with the “final” set of digital rights that were licensed. At step 618, “request” rights may be received from application teams that consume data licenses. At step 620, at renewal, “rights” may be compared to a final state of the contract. The process may be initiated again at step 610. While the process of FIG. 6 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 610, a contracting process may be initiated. For example, an analyst may initiate a contracting process through an embodiment of the present invention. This may occur via an interaction with a user interface displayed on a portal or other interface executing on a processor device or system.

At step 612, “orders” of rights may be received. For example, businesses may provide “orders” of rights. The “orders” may be gathered through a user interface in a portal, but ultimately converted and stored via ODRL. The order may identify a description of rights that are needed to achieve a certain business objective or goal. The order of rights may relate to a project, team, application, service, etc. as well as a portion of a larger project, team, application, service, etc. An atomic contracting process may involve receiving orders from one or more businesses, given the counterparty and dataset's adoption.

At step 614, an aggregate “order” may be identified during contract negotiation. For example, sourcing may have access to an aggregate “order” that may be used during negotiations, which represents a sum total of all requested rights in at step 612. The aggregate “order” may have additional details concerning team of interest, applications that are impacted, tiers of importance (e.g., required, critical, moderate, etc.). Other data may be identified for additional support, verification, justification, etc.

At step 616, a final contract may be generated or retrieved from another application or system. For example, the contract may be negotiated on an application or other service. The final contract may be moved from the application to an embodiment of the present invention. Analysts, lawyers, or sourcing personnel may describe rights it confers via an embodiment of the present invention, which may then be converted to a “final” ODRL.

At step 618, “request” rights may be received. For example, applications may “request” rights on behalf of businesses they serve, which may then be converted to ODRL. Requests from other sources may be received. The requests may be received after the contract is final and during regular course of business or other use case scenarios.

At step 620, at renewal, “rights” may be compared to a “final” state of the contract. Unused rights may be highlighted. An embodiment of the present invention may be used to better position a business for contract renewal. By comparing requests and the final contract, a business may have a clear picture of how the contract rights were consumed. For example, unused rights may be removed and used as leverage for contract negotiations. The process may be initiated again at step 610.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a contract analytics tool, the system comprising:
a portal that interfaces with user within a line of business via a network communication;
a memory component that stores data relating to a plurality of contracts associated with the line of business; and
an analytics engine that comprises a computer processor and is coupled to the memory component and the portal; the computer processor is further configured to perform the steps of:
initiating, via the portal, a contracting process;
receiving, via an electronic communication, one or more orders of rights for the line of business, wherein the one or more orders of rights relate to digital rights management (DRM);
identifying, via the analytics engine, an aggregate set of orders across multiple lines of business for a contract negotiation process;
accessing, via a contract application, a final contract; and
providing, via the portal, a visualization of the final contract within a tree structure that identifies parent and child contract relationships, applies corporate mapping for the multiple lines of business and provides search functionality based on key contract terms.

2. The system of claim 1, wherein the contracting process relates to one or more market data contracts.

3. The system of claim 1, wherein the computer processor is further configured to perform the steps of:
receiving, via the portal, one or more rights request; and
comparing, via the analytics engine, the one or more rights request to the final contract.

4. The system of claim 3, wherein responsive to the one or more rights request, a corresponding Open Digital Rights Language (ODRL) is automatically generated.

5. The system of claim 3, wherein responsive to the step of comparing, identifying one or more differences between the one or more rights request and the final contract and graphically displaying the one or more differences.

6. The system of claim 1, wherein the visualization comprises a corresponding expiration calendar that indicates when the contract is scheduled to expire.

7. The system of claim 1, wherein the computer processor is further configured to perform the steps of:
automatically generating an audit trail of the contracting process.

8. The system of claim 1, wherein the search functionality comprises an ability to search by one or more contract rights and to determine whether the one or more contract rights are consistent with the final contract.

9. The system of claim 1, wherein the visualization supports digital rights management (DRM) features that generate a set of computer readable rights that describe characteristics of the final contract.

10. The system of claim 1, wherein the tree structure is editable by a user interaction by an authorized user.

11. A method that implements a contract analytics tool, the method comprising the steps of:
initiating, via a portal, a contracting process, wherein the portal interfaces with a user within a line of business via a network communication;
receiving, via an electronic communication, one or more orders of rights for the line of business, wherein the one or more orders of rights relate to digital rights management (DRM);
identifying, via an analytics engine, an aggregate set of orders across multiple lines of business for a contract negotiation process;
accessing, via a contract application, a final contract; and
providing, via the portal, a visualization of the final contract within a tree structure that identifies parent and child contract relationships, applies corporate mapping for the multiple lines of business and provides search functionality based on key contract terms.

12. The method of claim 11, wherein the contracting process relates to one or more market data contracts.

13. The method of claim 11, further comprising the steps of:
receiving, via the portal, one or more rights request; and
comparing, via the analytics engine, the one or more rights request to the final contract.

14. The method of claim 13, wherein responsive to the one or more rights request, a corresponding Open Digital Rights Language (ODRL) is automatically generated.

15. The method of claim 13, wherein responsive to the step of comparing, identifying one or more differences between the one or more rights request and the final contract and graphically displaying the one or more differences.

16. The method of claim 11, wherein the visualization comprises a corresponding expiration calendar that indicates when the contract is scheduled to expire.

17. The method of claim 11, further comprising the step of:
automatically generating an audit trail of the contracting process.

18. The method of claim 11, wherein the search functionality comprises an ability to search by one or more contract rights and to determine whether the one or more contract rights are consistent with the final contract.

19. The method of claim 11, wherein the visualization supports digital rights management (DRM) features that generate a set of computer readable rights that describe characteristics of the final contract.

20. The method of claim 11, wherein the tree structure is editable by a user interaction by an authorized user.
